(19) United States
(12) Patent Application Publication
(10) Pub. No.: US 2009/0276962 A1
(43) Pub. Date: Nov. 12, 2009

(54) STRIKING TOOL

(76) Inventors: Robert Adams, Elk Grove Village, IL (US); Jared Hanlon, Santa Fe Springs, CA (US)

Correspondence Address: Joel Myers, Building 15 , Suite 325, 1827 Powers Ferry Road, Atlanta, GA, 30339, US

(21) Appl. No.: 12/387,762

(22) Filed: May 6, 2009

Related U.S. Application Data
(60) Provisional application No. 61/050,965, filed on May 6, 2008.

(51) Int. Cl. B25D 1/00; B66F 15/00

(52) U.S. Cl. 7/144; 7/166

(57) ABSTRACT

A multi-function tool having a handle portion and a plurality of structures operable therewith for the performance of a plurality of functions. The multi-function tool allows fast and convenient transition between any of the plurality of functions in order to enable completion of jobs or tasks requiring such functions without acquisition, storage, and/or maintenance of a plurality of specialized tools.

### PRIORITY CLAIM

This application hereby claims priority to provisional application No. 61/050,965 filed on May 6, 2008 and titled STRIKING TOOL.

### TECHNICAL FIELD

The present disclosure relates generally to hand tools, and, more particularly, to striking and demolition tools, such as a sledge hammer, or the like.

### BACKGROUND OF THE INVENTION

Because construction features can vary greatly even within a singular demolition site, a plurality of tools is frequently necessary to enable effective performance of demolition work. For example, removal of material may require a substantial chisel, or in some instances may necessitate the use of a lever for beneficial fulcrum action. Creation of a passageway through solid materials may require a hammer. Cutting and/or scraping away of waste sheet material may involve a sharpened cutting tool. Transport of such a collection of tools to a jobsite is a difficult and burdensome task in and of itself, but retaining mobility of such a number of tools while moving about a jobsite during work is disadvantageously time and energy consuming, and involves potential loss and/or theft of tools mislaid during periods of nonuse.

Further, demolition work can be exceedingly hard on workforce members and tools. Thus, not only does the nature of the work typically require a plurality of tools, each tool is repeatedly subject to high stress conditions and is therefore unlikely to remain capable for peak performance for any extended period of time. This disadvantage can increase the frequency of tool replacement, and given the plurality of tools necessary, can increase costs. Coupled with increased labor costs from time-inefficient tool transport and interchange, profit margins for demolition teams can plummet.

Further disadvantages may be realized directly by the workforce members. That is, in addition to time and material costs, worker performance can be compromised by premature exhaustion as a result of repeated expenditure of energy exchanging between a plurality of heavy tools, and necessarily transporting those tools about the demolition site.

Thus, it is clear that there is an unmet need for a striking and demolition tool that advantageously provides for user delivery of a variety of different forces to a demolition site, when applied according to the nature of the construction features, and coincidently maximize workforce energy and efficiency.

### BRIEF SUMMARY OF THE INVENTION

Briefly described, in an exemplary embodiment, the striking tool of the present disclosure overcomes the above-mentioned disadvantages and meets the recognized need for such a tool by providing a steel hammer having a head, a striking surface, a nail-pulling tool, a nail-starting tool, a sharpened surface, and including one or more cavity and/or void, and a handle having a strong yet lightweight construction and a chisel tool.

More specifically, the exemplary striking tool includes a generally extended handle portion with a striking head at a first end of the handle portion, and a chisel at a second end of the handle portion. The handle portion preferably includes a generally broad, flat forward surface adapted to reduce damage caused by overstrikes, i.e. poorly aimed strikes where an impact force is borne by the handle portion. A medial section of the handle portion, however, is generally thin compared to the broad forward surface, whereby a reduction in weight and advantageous balance is provided. A broad rearward surface is preferably also included for stability and strength of the handle portion. Additionally, a chisel or wedge is preferably included at the other end of the handle portion, wherein the chisel portion has a preferably broad front and rearward surface to facilitate effective delivery of prying forces. The handle portion may also include a comfortable grip operable therewith to provide a comfortable and secure gripping surface by which a user may grasp the tool.

The striking head preferably includes a cavity extending from the rear of the striking head to the rear of the striking face and into the claw zone. The cavity thus preferably defines an upper chamber portion and a lower chamber portion. The chamber portions preferably reduce vibrations caused by strikes, and substantially prevent transmission of vibrations to the handle portion, while further enabling distribution of sufficient mass to safely and reliably allow accurate delivery of forceful strikes without causing excessive strain or fatigue.

More specifically, the striking face is preferably provided on a forward surface of the head, and the chamber portions, particularly the upper chamber portion, are arranged to substantially redirect force and facilitate tool balance. The nail-pulling tool is preferably disposed as a recess in the rear upper surface portion of the head. The triangular perimeter of the nail-pulling tool facilitates easy entry of a nail head into the broad end of the recess, with slidable engagement proximate the narrow end for delivery of pulling forces. The chamber portions, particularly the lower chamber portion, are arranged to substantially prevent bending between the nail-pulling tool and the handle portion.

The nail start tool is preferably disposed within the front upper portion of the head, and extends transversely through the side upper portions of the head. The nail start tool thus defines an accessway through which a nail head may be slidably inserted, from either side, and with the nail point directed via a groove in the front upper portion of the head, the nail is thus secured for start assistance. A sharpened surface is preferably provided proximate the rear of the head, in the traditional claw zone, that is, the area where a claw may be provided. The sharpened surface preferably extends, according to an arcuate path, from the rear upper surface edge of the head to the handle, and along both rear side edges of the head. The preferred configuration for the sharpened surface facilitates delivery of cutting forces, such as in the manner of an axe, or the motion of a scythe, i.e., to deliver chops and slices.

Accordingly, one feature and advantage of the tool of the present disclosure is its ability to provide a strong, yet lightweight handle portion having a broad flat forward surface adapted to reduce damage caused by overstrikes.

Another feature and advantage of the tool of the present disclosure is its ability to provide a durable striking tool capable of delivering great impact forces while providing a beneficial weight distribution and balance for ease of use.

Yet another feature and advantage of the tool of the present disclosure is its ability to provide a plurality of on-board tools to efficiently assist in the accomplishment of a plurality of demolition tasks.

Still another feature and advantage of the tool of the present disclosure is its ability to perform as a balanced lever for transfer and/or magnification of forces.

Yet still another feature and advantage of the tool of the present disclosure is its ability to provide a sharpened cutting tool for cutting materials, such as waste sheetrock material.

Still yet another feature and advantage of the tool of the present disclosure is its ability to eliminate the need for the transport of a plurality of specialized tools to a demolition site or other worksite.

Another feature and advantage of the tool of the present disclosure is its ability to provide for user delivery of a variety of different forces to a demolition site, according to a variety of needs, such as those imposed by the nature of the construction features.

Still another feature and advantage of the tool of the present disclosure is its ability to provide a nail engagement region to offer assistance with nail starts.

And yet still another feature and advantage of the tool of the present disclosure is its ability to provide a cutting surface that can deliver cutting forces in the manner of an axe and in the motion of a scythe.

These and other features and advantages of the tool of the present disclosure will become more apparent to those ordinarily skilled in the art after reading the following Detailed Description of the Invention and Claims in light of the accompanying drawing Figures.

### BRIEF DESCRIPTION OF THE DRAWINGS

Accordingly, the present disclosure will be understood best through consideration of, and with reference to, the following drawings, viewed in conjunction with the Detailed Description of the Invention referring thereto, in which like reference numbers throughout the various drawings designate like structure, and in which:

FIG. 1 is a perspective view of the striking tool of the present disclosure, according to a preferred embodiment;

FIG. 2A is a front view of the striking tool of FIG. 1;

FIG. 2B is a cross-sectional view of a head of the striking tool of the present disclosure, taken along line A-A; and

FIG. 3 is a side view of the striking tool of FIG. 1.

It is to be noted that the drawings presented are intended solely for the purpose of illustration and that they are, therefore, neither desired nor intended to limit the scope of the disclosure to any or all of the exact details of construction shown, except insofar as they may be deemed essential to the claimed invention.

### DETAILED DESCRIPTION OF THE INVENTION

In describing exemplary embodiments of the tool of the present disclosure illustrated in the drawings, specific terminology is employed for the sake of clarity. The claimed invention, however, is not intended to be limited to the specific terminology so selected, and it is to be understood that each specific element includes all technical equivalents that operate in a similar manner to accomplish a similar purpose.

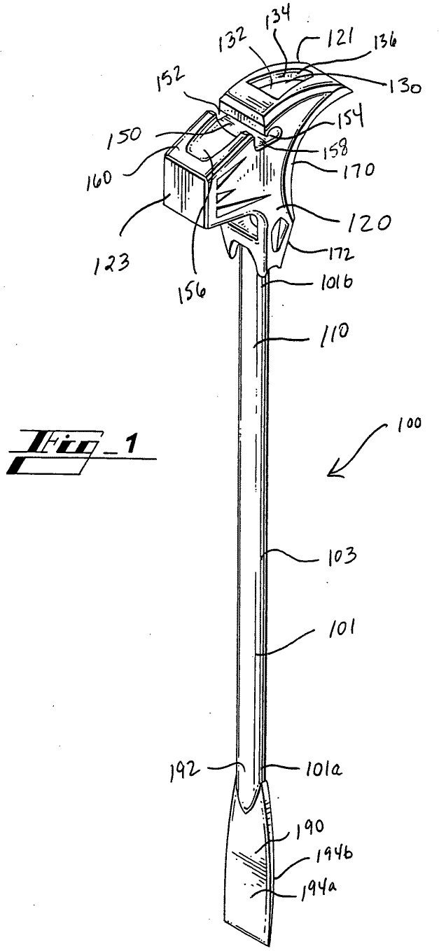

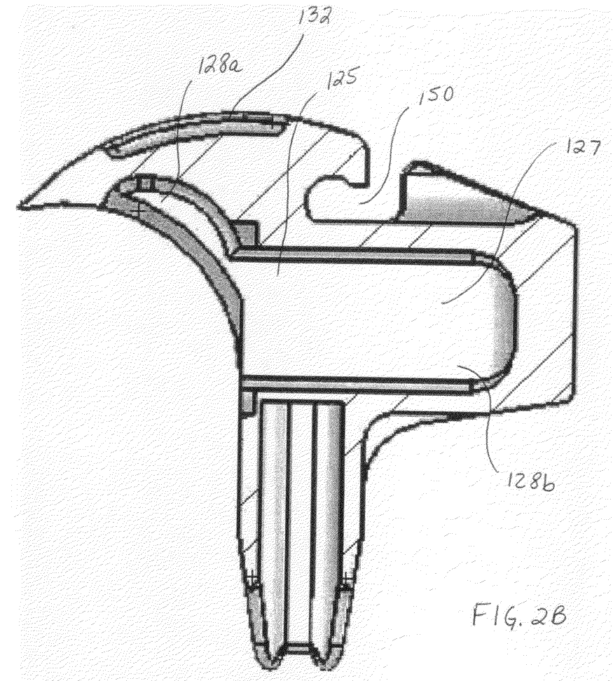

In that form of the sledge hammer of the present disclosure chosen for purposes of illustration, FIGS. 1-3 show hammer 100 including body 101 and grip 103. Body 101 is preferably formed from a suitable metal, composite, or synthetic material, or the like, defining handle 110 and head 120, and may include grip 103 formed or installed thereon. Grip 103 may be formed from natural or synthetic rubber, plastic, composite, or the like, and may be resilient and/or sculptured or contoured to provide a comfortable and secure grasping surface. Grip 103 may extend from first end 101a of body 101 proximate a distal end of handle 110 to second end 101b of body 101, wherein head 120 is preferably disposed proximate a distal end of handle 110 at second end 101b of body 101.

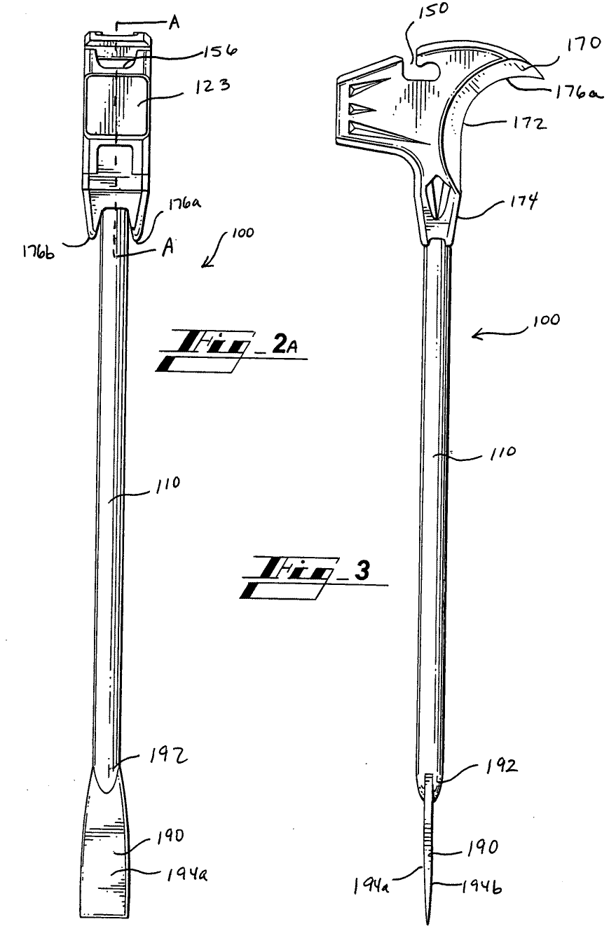

Referring now particularly to FIG. 2B, head 120 preferably further includes cavity 125 and a plurality of chambers 127, preferably upper chamber 128a and lower chamber 128b. Cavity 125 preferably serves to reduce a total mass of head 120 and to reduce transmission and/or creation of vibrations as may occur from striking impacts. Chambers 127 are operable to absorb and/or dissipate off-axis forces, such as those that may cause vibration. Thus, vibrations are preferably not substantially transmitted to handle 110.

Head 120 preferably includes claw zone 121 disposed on a rearward portion thereof, wherein nail pulling tool 130 of head 120 is adapted to pry articles, such as nails, boards, or the like, via application of force to handle 110. As will be further discussed hereinbelow, the configuration of the rearward portion of head 120 facilitates the realization of lever action benefits during such use. Striking surface 123 is preferably disposed on a forward portion of head 120 and is adapted to deliver a striking force to a selected target. Striking surface 123 may optionally include a plurality of teeth or other texture, such as a waffle pattern, a diamond pattern, or the like.

Head 120 preferably further includes nail-pulling tool 130, nail-starting tool 150, and sharpened surface 170. Nail-pulling tool 130 is preferably formed as recess 132, wherein preferably, triangular-shaped peripheral boundary 134 is dimensioned to permit reception of a nail head within recess 132. Slidable engagement of such a nail head is preferably facilitated by peripheral boundary 134 proximate narrow end 136 of nail-pulling tool 130.

Nail-starting tool 150 is preferably disposed as canyon 152, having cavern 154 and shelf 156. Preferably, cavern 154 extends transversely across head 120, with openings 158 opposingly defined on each side of head 120. Shelf 156 preferably defines a trough that extends from cavern 154, along upper surface 160 of head 120, and that ends proximate striking face 123. Openings 158 of nail start tool 150 thus define an accessway through which a nail head may be slidably inserted, from either side of head 120, with the nail point directed via shelf 156 to a generally secure position for start assistance. In this preferred configuration, a user may utilize nail start tool 150 to assist in positioning and retaining a nail with the sharpened end extending outwardly from striking face 123 of head 120, and may thus utilize nail start tool 150 as an effective method for initially placing a nail, without risk of finger trauma, such as to fingers holding a nail in place pending placement.

Sharpened surface 170 is preferably provided proximate rear 172 of head 120, extending from claw zone 121 to rear, broadened overstrike zone 174. Sharpened surface 170 is preferably defined according to an arcuate path along both rear side edges 176a, 176b of head 120, thereby facilitating delivery of cutting forces, such as in the manner of an axe, or the motion of a scythe. Sharpened surface 170 is preferably a metal blade; however, one skilled in the art would understand that that any suitable material with appropriate capacity for sharpening could be utilized.

As with head 120, handle 110 is preferably configured to provide durability and/or strength while reducing a total mass thereof and while providing a beneficial balance or distribution of mass. Additionally, pry bar tool 190 is preferably included at a distal end 192 of handle 110. Pry bar tool 190 is preferably formed as a chisel or wedge having broad front and rearward surfaces 194a, 194b, respectively, to facilitate effective delivery of prying forces. Handle 110 may also include a comfortable grip operable therewith to provide a comfortable and secure gripping surface by which a user may grasp the tool.

Head 120 may also include additional voids (not shown) formed therein at selected locations to both reduce the mass of head 120 and to produce a desired balance of head 120 while not substantially reducing a strength and/or durability thereof.

Having thus described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A tool comprising:
a handle portion adapted to be gripped by a user; and
a plurality of structures operable with said handle portion and adapted to perform at least one respective function,
wherein said plurality of structures comprises at least a striking surface for delivering a striking force to a workpiece, a first-class lever, a second-class lever, and a blade.

2. The tool of claim 1, wherein said plurality of structures further comprises a chisel.

3. The tool of claim 1, wherein said plurality of structures further comprises a nail-starting tool.

4. The tool of claim 3, wherein said nail-starting tool is further comprises of a multi-level opening disposed proximate said striking surface and said first class lever.

5. The tool of claim 4, wherein said multi-level opening is defined by a cavern extending transversely across a head of said tool and a groove extending lengthwise along said head of said tool, proximate and forward of said cavern.

6. The tool of claim 1, wherein said plurality of structures further comprises a nail-removal tool.

7. The tool of claim 7, wherein said nail-removal tool is a triangular-shaped recess disposed proximate said striking surface and said first class lever.

8. The tool of claim 1, wherein said blade is formed over a length of an edge of said tool.

9. The tool of claim 1, wherein said first class lever comprises a handle portion operable as a pry bar.

10. The tool of claim 1, further comprising at least one central cavity disposed proximate said striking surface and said lever.

11. A device for performing a plurality of work functions comprising:
a body having a handle portion and a first and second divergent projection at a first end;
a hammer striking surface disposed on said first divergent projection;
a claw zone disposed on said second divergent projection;
an open canyon disposed between said first and second divergent projections;
a triangular recess disposed between said first and second divergent projections;
a chisel disposed on a second end of said body proximate said handle portion; and
a blade disposed proximate said claw zone.

12. A multi-purpose demolition tool, comprising:
an elongated handle;
a wedge tool disposed proximate a distal end of said elongated handle; and
a hammer head tool disposed proximate a proximal end of said elongated handle.

13. The multi-purpose demolition tool of claim 12, wherein said hammer head tool further comprises a sledge hammer striking surface.

14. The multi-purpose demolition tool of claim 12, wherein said hammer head tool further comprises a cavity disposed therewithin.

15. The multi-purpose demolition tool of claim 12, wherein said hammer head tool further comprises a nail-start tool, wherein said nail-start tool comprises a multi-level aperture with openings in an upper surface and a first and second side surfaces of said hammer head tool.

16. The multi-purpose demolition tool of claim 12, wherein said hammer head tool further comprises a nail-removal tool disposed as a recess in an upper surface of said hammer head tool.

17. The multi-purpose demolition tool of claim 12, wherein said hammer head tool further comprises a blade.

18. The multi-purpose demolition tool of claim 17, wherein said blade is arcuately-shaped.

19. The multi-purpose demolition tool of claim 17, wherein said blade is disposed generally along a longer rearward edge of said hammer head tool.
